(19) United States
(12) Patent Application Publication
(10) Pub. No.: US 2017/0255770 A1
(43) Pub. Date: Sep. 7, 2017

(54) Optical Unlocking Device

(71) Applicant: Beijing Jiatuosi Technology Co., Ltd., Beijing (CN)

(72) Inventors: Jia'e Yang, Weinan (CN); Dazhi Feng, Haerbin (CN); Mingxin Hou, Haerbin (CN)

(21) Appl. No.: 15/191,512

(22) Filed: Jun. 23, 2016

(30) Foreign Application Priority Data
Mar. 1, 2016 (CN) 201610114247.5

(51) Int. Cl. G06F 21/36; G06F 3/01; G06F 3/03

(52) U.S. Cl. CPC G06F 21/36; G06F 3/0304; G06F 3/017

(57) ABSTRACT

An optical unlocking device for identifying user operation through optical projection and acquisition so as to unlock a device or a program, and the unlocking device specifically includes a software algorithm module, a hardware module and a valid operation area. The hardware module includes an optical emission module, an image acquiring module and a processor. Unlocking method includes the following steps: firstly, acquiring and analyzing user operation data; secondly, extracting the characteristic data information about the area of interest; and making a judgment on unlocking or status switchover by comparing the characteristic data.

### CROSS-REFERENCE TO RELATED APPLICATIONS

The present application claims the benefit of Chinese Patent Application No. 201610114247.5 filed on Mar. 1, 2016, the contents of which are hereby incorporated by reference.

### FIELD OF THE INVENTION

The invention relates to an optical unlocking device, in particular to optical projection, detection and processing for unlocking the device.

### BACKGROUND

At present, more and more home entertainment devices and electronic products are taking non-contact gesture control for man-machine interaction. Since a non-contact gesture control system will usually respond to the gesture of a user, the unintentional gesture of the user may result in misoperation of the system. Therefore, the non-contact control system needs locking and unlocking functions.

In the new optical projection computer field, people use optical projection keyboard as input means and optical projection head as output means. However, people sometimes wish their devices to enter into a standby status or low-consumption status as they may not use the optical projection keyboard in a long time for some reason, or will leave temporarily without shutting down their devices or due to other reasons. When operating the device again, people want to their devices return back to normal operating status safely and quickly. At this time, the device requires locking and unlocking functions.

The non-contact unlocking method includes an unlocking method based on three-dimensional gesture, but extraction of three-dimensional information and identification of gesture will occupy a large amount of system resources, consume much time, cause delay and easily result in error identification. Besides, there is also a gesture unlocking method based on skin color. However, as skin color on the one hand is easily interrupted by the environment and complexion, and gesture on the other hand is required to face a camera, this method will limit the angle of use and affect the comfortability of the user in use.

### SUMMARY OF THE INVENTION

The invention discloses an optical unlocking device for identifying user gesture through optical projection and acquisition so as to quickly switch status, such as from a locking status to an unlocking status, from an unlocking status to a locking status or from one application status to another application status. The invention specifically relates to the following contents:

An optical unlocking device includes a valid operation area, a hardware module and a software algorithm module. The hardware module includes an optical emission module, an image acquiring module and a processor, wherein the optical emission module is used for providing and emitting a primary light source; the image acquiring module is used for acquiring user operation information; the processor is used for receiving electric signals or sending electric signals to the image acquiring module and/or optical emission module or operating related algorithms and unlocking programs; the valid operation area is covered by the light emitted from the optical emission module and can be identified by the image acquiring module; and the software algorithm module is used for acquiring and analyzing the user operation data and making a judgment on unlocking.

Further, the light projected by the optical emission module can be identified by human eyes, the shape of the projected light is planar light or overlapped planar light, and the intensity of the projected light is adjustable.

Further, the image acquiring module obtains user operation information within the valid operation area through the reflection of light; and the image acquiring module is composed of one or multiple light-sensitive elements in combination.

Further, the unlocking method of the optical unlocking device includes the following steps of:

an image data acquiring step for obtaining the data information output by the image acquiring module;

an operating characteristic extracting step for extracting characteristic data information from the data information, including static characteristic data and dynamic characteristic data;

a step for judging whether the current operating characteristics are identical with the pre-defined unlocking characteristics through comparing the characteristic data information and the preset unlocking characteristic information; and

an unlocking realization step for switching the status to unlocking status when the characteristic data information is matched with the preset unlocking characteristics; or a step for maintaining locking status for maintaining the locking status when the characteristic data information is not matched with the preset unlocking characteristics.

Further, the static characteristic data are single-frame data.

Further, the basic characteristic data information contained in the single-frame data includes number of operating fingers, size of finger and palm mode or fist clenching mode.

Further, the dynamic characteristic data are multi-frame data, and the basic characteristic data contained in the multi-frame data are motion characteristic information.

Furthermore, the motion characteristic information includes operating speed, accelerated speed, track, starting and ending coordinates or starting or ending area.

Compared with the prior art, the beneficial effects of the invention are as follows:

(1) The invention solves the problem of locking and unlocking related devices in the optical computer field.

(2) The invention uses laser to identify non-contact input information, has simple post processing, can obtain usable information quickly and effectively reduce environmental disturbance.

(3) The unlocking method of the invention is distinct and easy to operate. Furthermore, related modules are designed into architecture modules, and designers can achieve better design effects only by upgrading based on corresponding modules.

### BRIEF DESCRIPTION OF THE DRAWINGS

FIG. 1 is an overall architecture chart of the first embodiment of the invention.

FIG. 2 is a schematic diagram of the unlocking algorithm in the first embodiment of the invention.

FIG. 3 is a structural diagram of the unlocking device in the second embodiment of the invention.

FIG. 4 is the first schematic diagram of the installation position of a key module in the third embodiment of the invention.

FIG. 5 is the second schematic diagram of the installation position of a key module in the fourth embodiment of the invention.

### DESCRIPTION OF THE PREFERRED EMBODIMENTS

The invention will be further described in detail in combination with accompanied drawings and embodiments.

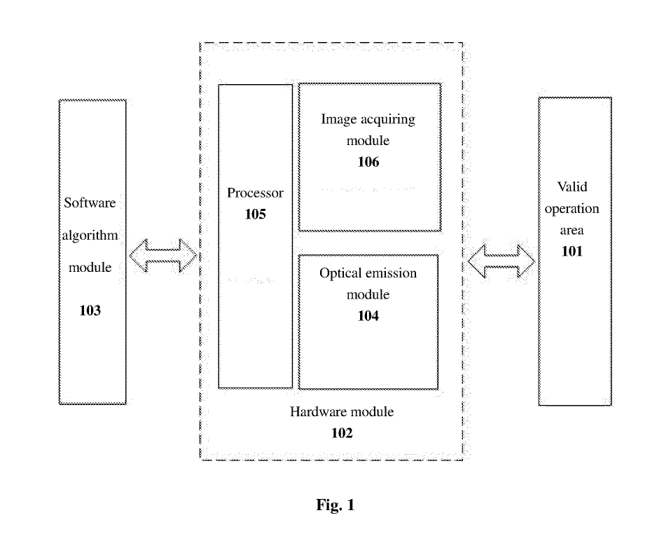

The embodiment of the optical unlocking device of the invention is shown in FIG. 1. In order to achieve the due effect, importance must be attached to selection and installation position of the hardware module.

The first embodiment: In the embodiment of the invention, the optical unlocking device includes a valid operation area 101, a hardware module 102 and a software algorithm module 103. Wherein, the hardware module includes an optical emission module 104, an image acquiring module 106 and a processor 105. Wherein, the optical emission module 104 provides a primary light source specifically including laser, radial or light that can be identified by human eyes. With strong power and good monochromaticity, laser is easy to form glaze with good effect. The light projected by the optical emission module 104 shall be planar light and is usually output in a sector form. However, simple change to the shape of light plane or simple increase of the number of optical emission sets is also considered belonging to the scope of the invention.

The image acquiring module 106 is used for acquiring user operation information and can be provided with such light-sensitive transfer elements as camera and area array CCD.

The processor 105 is used for receiving electric signals or sending electric signals to the image acquiring module and/or optical emission module or can be also selected to operate corresponding algorithms and unlocking programs. Specifically, the processor can be designed by selecting one or several of ARM, DSP, FPGA, single chip or other chips in combination, or designed by a user chip or other types of processor chips.

Wherein, the position relation (such as relative distance, relative angle and relative position) between the image acquiring module 106 and the optical emission module 104 is very important, and different position relations determine different valid operation areas. Wherein, the valid operation area 101 is covered by the light emitted from the optical emission module 104 and identified by the image acquiring module 106.

Wherein, the software algorithm module 103 operates a specific unlocking algorithm in the processor 105. Meanwhile, such function algorithm as status switching expanded based on the unlocking algorithm shall be also considered belonging to the protection scope of the invention.

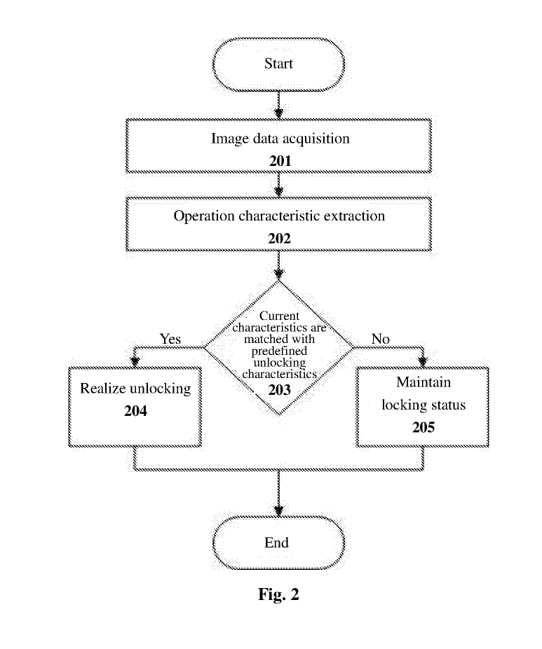

The unlocking method of the unlocking device in the invention is shown in FIG. 2 and specifically includes the following steps of:

an image data acquiring step 201 for obtaining the data information output by the image acquiring module and including image preprocessing and other corresponding algorithms such as graying, expanding corrosion, contour extraction and other corresponding preprocessing steps; and

an operating characteristic extracting step 202 for extracting characteristics from related information upon processing, including static characteristic data and dynamic characteristic data.

Wherein, the static data information can be understood as single-frame data characteristics. With a camera as an example, static data information can be a frame at some moment, based on which, user operation information can be identified. For example, gesture information may include the number of operating fingers within the valid operation area 101, palm mode or fist clenching mode. Wherein, the dynamic data information can be understood as multi-frame data, data characteristics between frames, such as the motion track of a characteristic gesture, operating speed, acceleration and change data characteristics of gesture.

A step 203 for judging whether the current operating characteristics are identical with the predefined unlocking characteristics, which can be understood as a process of comparing the static or dynamic information obtained from step 202 with the predefined data information required by unlocking. The predefined data information may include movement from one characteristic position to another characteristic position, motion track confirming to certain shape, some special change to operating speed or acceleration, static data characteristics with certain characteristics, and change to static data, etc. The unlocking characteristics can be understood as one or several predefined information data in combination as described above.

An unlocking realization step 204, that is when the condition in step 203 is met, status is changed from locking to unlocking or from unlocking to locking. Besides, the step may include certain subsequent execution steps, such as switching on or shutting down some corresponding electronic devices.

A step for maintaining locking status 205, that is, maintaining the locking status, which results in unlocking failure.

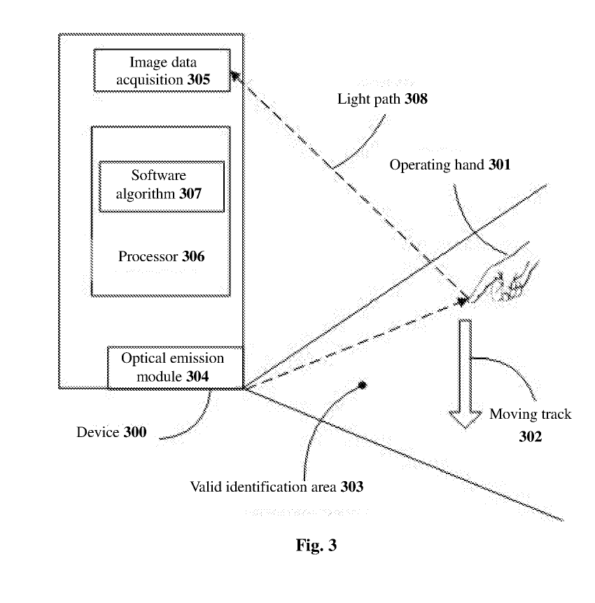

The second embodiment: For FIG. 3, the embodiment of the optical unlocking device of the invention is shown in the following example that device 300 illustrates a simple device containing the fundamental elements of the invention.

Wherein, the optical emission module 304 is planar infrared laser emitting module generating a sector laser coverage area and is installed at the bottom of the device 300. The image acquiring module 305 is preferably a camera, installed above the device 300, and the area that can be captured by the camera and the sector laser coverage area will form a valid operation area 303.

The algorithm 307 is operated in the processor 306, and the operating characteristics predefined in the algorithm include a static characteristic (of 4 fingers) and a dynamic characteristic (of movement along moving track 302). When an operator has 4 fingers in the valid operation area 303 and moves based on the moving track 302, the unlocking module identifies that the operating characteristics are matched with the predefined operating characteristics, so that the device is unlocked and corresponding unlocking program is executed. When the operating characteristics are not matched with the predefined operating characteristics, the device is still locked.

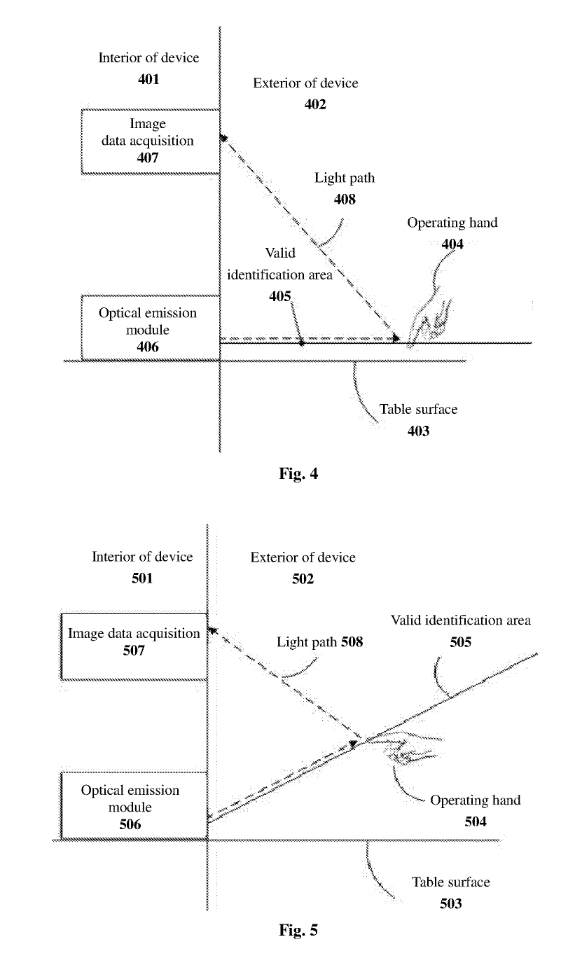

The third embodiment: the example is designed to illustrate a position relation between the optical emission module and the data acquiring module. FIG. 4 is an overall side view of the device in operating status, wherein the internal area 401 of the device is at left, the external area 402 of the device is at right, and the device is placed on a table surface 403.

The third embodiment is characterized by describing that the laser projected by the optical emission module 406 is parallel to the table surface, thus the valid operation area 405 formed by the optical emission module 406 and the image data acquiring module 407 is also a laser surface parallel to the table surface.

When an operating hand 404 operates in the valid operation area 405, light is emitted through the optical emission module 406, reflected by the operating hand 404, and finally acquired by the image data acquiring module 407 to form a light path 408. Wherein, it shall be noted that the part in the light path before the light from the optical emission module 406 is reflected by the operating hand 404 is actually located in the valid operation area 405, and the form of the part in FIG. 4 is to clearly describe the condition of the light path 408.

The unlocking process is the process of the operating hand 404 statically operating or moving in the valid operation area 405 (refer to related description in the second embodiment for detailed realization).

The operation area of the example is the table surface, thus the operator can operate in the valid operation area 405 on the table surface conveniently and quickly, such as touch and movement of single or multiple fingers.

The fourth embodiment: the example is designed to illustrate another position relation between the optical emission module and the data acquiring module. FIG. 5 is an overall side view of the device in operating status, wherein the internal area 501 of the device is at left, the external area 502 of the device is at right, and the device is placed on the table surface 503.

The fourth embodiment is characterized by describing that the laser projected by the optical emission module is not parallel to the table surface and forms a certain angle with the table surface, thus the valid operation area 505 formed by the optical emission module 506 and the image data acquiring module 507 will also form a certain angle with the table surface and is located in the space above the table surface.

When an operating hand 504 operates in the valid operation area 505, light is emitted through the optical emission module 506, reflected by the operating hand 504, and finally acquired by the image data acquiring module 507 to form a light path 508. Wherein, it shall be noted that the part in the light path before the light from the optical emission module 506 is reflected by the operating hand 504 is actually located in the valid operation area 505, and the form of the part in FIG. 5 is to clearly describe the condition of the light path 508.

The unlocking process is the process of the operating hand 504 statically operating or moving in the valid operation area 505 (refer to related description in the second embodiment for detailed realization).

The operation area of the fourth embodiment extends to space, which is convenient to capture some gestures of the operator in space, such as wave in the valid operation area 505, so that the user can operate more comfortably and conveniently.

Above embodiments, the structure and the unlocking method of the unlocking device of the first embodiment, the second embodiment, the third embodiment and the fourth embodiment are all the same.

The contents above are further detailed description of the invention in combination with embodiments, but the examples of the invention cannot be limited to the description. Without departing from the concept of the invention, a person skilled in the art can make more simple deduction or replacement, which shall be included in the protection scope of the invention.

What is claimed is:

1. An optical unlocking device, comprising a valid operation area, a hardware module and a software algorithm module, the hardware module comprising an optical emission module, an image acquiring module and a processor, wherein,
the optical emission module is used for providing and emitting a primary light source;
the image acquiring module is used for acquiring user operation information;
the processor is used for receiving or sending electric signals to the image acquiring module and/or optical emission module or operating related algorithms and unlocking programs;
the valid operation area is covered by the light emitted from the optical emission module and can be identified by the image acquiring module; and
the software algorithm module is used for acquiring and analyzing the user operation data and making a judgment on unlocking.

2. The optical unlocking device according to claim 1, wherein the light projected by the optical emission module can be identified by human eyes, the shape of the projected light is planar light or overlapped planar light, and the intensity of the projected light is adjustable.

3. The optical unlocking device according to claim 1, wherein the image acquiring module obtains user operation information within the valid operation area through the reflection of light; and the image acquiring module is composed of one or multiple light-sensitive elements in combination.

4. An unlocking method of the optical unlocking device according to claim 1, comprising the following steps of:
obtaining the data information output by the image acquiring module;
extracting characteristic data information from the data information, and the characteristic data comprises static characteristic data and dynamic characteristic data;
judging whether the current operating characteristics are identical with the predefined unlocking characteristics through comparing the characteristic data information with the preset unlocking characteristic information; and
switching the status to unlocking status when the characteristic data information is matched with the preset unlocking characteristics; or maintaining the locking status when the characteristic data information is not matched with the preset unlocking characteristics.

5. The unlocking method of the optical unlocking device according to claim 4, wherein the static characteristic data are single-frame data.

6. The unlocking method of the optical unlocking device according to claim 5, wherein the basic characteristic data information contained in the single-frame data comprises number of operating fingers, size of finger and palm mode or fist clenching mode.

7. The unlocking method of the optical unlocking device according to claim 4, wherein the dynamic characteristic data are multi-frame data, the basic characteristic data contained in the multi-frame data are motion characteristic information.

8. The unlocking method of the optical unlocking device according to claim 7, wherein that the motion characteristic information comprises operating speed, acceleration, track, starting and ending coordinates or starting or ending area.
